(19) United States
(12) Patent Application Publication
(10) Pub. No.: US 2010/0264769 A1
(43) Pub. Date: Oct. 21, 2010

(54) INDUCTION MOTOR HAVING ROTORS ARRANGED CONCENTRICALLY AND BEING ABLE TO USED TO GENERATOR

(76) Inventor: Kye-Jung Park, Daegu (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/744,006

(22) PCT Filed: Nov. 18, 2008
(86) PCT No.: PCT/KR08/06776

§ 371 Date: Jun. 8, 2010

(30) Foreign Application Priority Data
Nov. 20, 2007 (KR) 10-2007-0118822

(51) Int. Cl. H02K 17/18

(52) U.S. Cl. 310/125

(57) ABSTRACT

The present invention relates to an induction motor having multi-stage rotors arranged concentrically and being usable as a generator. More particularly, the present invention relates to an induction motor, which includes a core having conductive bars arranged in multi stages and coils arranged in multi stages, and which is usable as a generator. The present invention may be applied to a hub type, in which a shaft is fixed and a housing of the induction motor is rotated, and a rotation type, in which the housing is fixed and the shaft is rotated. According to one aspect of the present invention, the induction motor according to the present invention includes a rotor and a stator. Here, the rotor includes a plurality of cylindrical cores arranged in multi stages in a radial direction, each of the cores having a plurality of grooves formed in an axial direction on a periphery thereof and arranged along a circumferential direction, and a plurality of conductive bars inserted into the grooves of the core of each stage. In addition, the stator includes armature cores arranged in one or more stages in a radial direction to face the periphery having the grooves formed thereon, and a plurality of armature coils wound around the armature cores to correspond to the respective conductive bars.

### TECHNICAL FIELD

The present invention relates to an induction motor having multi-stage rotors arranged concentrically and being usable as a generator. More particularly, the present invention relates to an induction motor, which includes a core having conductive bars arranged in multi stages and coils arranged in multi stages, and which is usable as a generator. The present invention may be applied to a hub type, in which a shaft is fixed and a housing of the induction motor is rotated, and a rotation type, in which the housing is fixed and the shaft is rotated.

### BACKGROUND ART

A motor is a device for generating mechanical movement using electric energy. Such a motor is classified into a DC motor (or a commutator motor) using DC electricity and an induction motor using AC electricity. The induction motor is also classified into a single-phase AC motor and a three-phase AC motor. The single-phase AC motor is generally used for home appliances, such as washing machines and sewing machines, and the three-phase AC motor is generally used as power equipment in a factory, a building, or the like.

A conventional induction motor includes a central shaft, a stator and a rotor. The stator has an armature core and a coil wound around the armature core, and generates a rotating magnetic field. The armature core is made by laminating thin silicon steel sheets so as to minimize a hysterisis loss in a magnetic substance. The rotor comprises a laminated core having grooves formed thereon, and conductive bars provided in the grooves and made of aluminum or copper.

If power is applied to the coil of the armature coil, a rotating magnetic field is generated, and then, the rotating magnetic field causes an induced current to be generated in the conductive bars. Electromagnetic force is generated by the rotating magnetic field and the induced current, thereby rotating the rotor.

Such an induction motor has a simple structure as well as does not need parts such as a commutator and a brush, so that it is widely used. Also, this induction motor may generate electricity by rotating the rotor inversely, so that it may be used as a generator. In particular, the induction motor may be used for wind power generators and large power generators.

### DISCLOSURE OF INVENTION

### Technical Problem

A conventional induction motor has a one-stage coil and a one-stage core. Thus, the conventional induction motor should have a great volume so as to provide sufficient output power, and if the induction motor has a small volume, small torque is generated since electromagnetic force is very small. Therefore, a power unit using such an induction motor has a problem in that it may not provide sufficiently high output power in comparison to its size.

The present invention is conceived to solve the aforementioned problems. That is, an object of the present invention is to provide an induction motor capable of providing strong output power even with a small size.

### Technical Solution

An induction motor according to the present invention includes a rotor and a stator. Here, the rotor includes a plurality of cylindrical cores arranged in multi stages in a radial direction, and a plurality of conductive bars. Each of the cores has a plurality of grooves formed in an axial direction on a periphery thereof and arranged along a circumferential direction, and the conductive bars are inserted into the grooves of the core of each stage. In addition, the stator includes armature cores and armature coils. The armature cores are arranged in one or more stages in a radial direction to face the periphery having the grooves of the core formed thereon. A plurality of the armature coils are wound around the armature cores to correspond to the respective conductive bars.

In addition, in the induction motor, the grooves are preferably formed on an inner periphery of the cores.

One embodiment of the induction motor may further comprise a fixed shaft positioned at a rotation center of the rotor. In such a case, the rotor further includes a core coupling means for rotatably coupling each core to the fixed shaft. In addition, the stator further includes an armature core coupling means for fixing each armature core to the fixed shaft.

In one embodiment of the induction motor, the core coupling means preferably includes a rotary disk having one surface coupled to one side of each core, the rotary disk being rotatably coupled to the fixed shaft. In addition, the armature core coupling means preferably includes a fixed disk having one surface coupled to one side of each armature core arranged between the respective cores, the fixed disk being fixed to the fixed shaft.

Further, in one embodiment of the induction motor, it is preferable that the rotor further include grooves formed on an outer periphery of the core opposite to the inner periphery in a radial direction and a plurality of conductive bars inserted into the grooves formed on the outer periphery. In addition, it is preferable that the stator further include a plurality of armature coils wound around the armature cores positioned between the respective cores corresponding to the conductive bars inserted into the grooves formed in the outer periphery.

Furthermore, in one embodiment of the induction motor, among the armature cores, the armature core adjacent to the fixed shaft is preferably fixed to the fixed shaft.

Moreover, in one embodiment of the induction motor, it is preferable that the core be detachably coupled to the rotary disk.

Another embodiment of the induction motor may further comprise a rotary shaft positioned at a rotation center of the rotor. In such a case, the rotor further includes a core coupling means for fixedly coupling each core to the rotary shaft. In addition, the stator further includes an armature core coupling means for relatively rotatably fixing each armature core to the rotary shaft.

In the other embodiment of the induction motor, the core coupling means preferably includes a rotary disk having one surface coupled to one side of each core, the rotary disk being fixed to the rotary shaft. In addition, the armature core coupling means preferably includes a fixed disk having one surface coupled to one side of each armature core, the fixed disk being relatively rotatably fixed to the rotary shaft.

Further, in the other embodiment of the induction motor, it is preferable that the rotor further include grooves formed on an outer periphery of the core opposite to the inner periphery in a radial direction and a plurality of conductive bars inserted into the grooves formed on the outer periphery. In addition, it is preferable that the stator further include a plurality of armature coils wound around the armature cores positioned between the respective cores corresponding to the conductive bars inserted into the grooves formed in the outer periphery.

Furthermore, in the other embodiment of the induction motor, it is preferable that the core be detachably coupled to the rotary disk.

In a further embodiment of the induction motor, the rotor further includes the cylindrical cores in one or more stages, which are further arranged in the axial direction, and the conductive bar. In addition, the stator further includes the armature cores arranged to face the further arranged cylindrical cores and the plurality of the armature coils.

The further embodiment of the induction motor may further comprise a fixed shaft positioned at a rotation center of the rotor. In such a case, the rotor further includes a core coupling means for rotatably coupling each core to the fixed shaft. In addition, the stator further includes an armature core coupling means for fixedly coupling each armature core to the fixed shaft.

Moreover, in the further embodiment of the induction motor, the core coupling means preferably includes a rotary disk having one surface coupled to one side of each of the cores arranged in multi stages in the radial direction, the rotary disk being rotatably coupled to the fixed shaft, the rotary disk being arranged in at least one stage in the axial direction. In addition, the armature core coupling means preferably includes a fixed disk having one surface coupled to one side of each of the armature cores arranged in one or more stages in the radial direction, the fixed disk being fixedly coupled to the fixed shaft, the fixed disk being arranged in at least one stage in the axial direction.

Also, in the further embodiment of the induction motor, it is preferable that the rotor further include grooves formed on an outer periphery of the core opposite to the inner periphery in a radial direction and conductive bars inserted into the grooves formed on the outer periphery. In addition, it is preferable that the stator further include a plurality of armature coils wound around the armature cores positioned between the respective cores corresponding to the conductive bars inserted into the grooves formed in the outer periphery.

Moreover, in the further embodiment of the induction motor, among the armature cores, the armature core adjacent to the fixed shaft is preferably fixed to the fixed shaft.

Furthermore, in the further embodiment of the induction motor, it is preferable that each core be detachably coupled to the rotary disk.

Meanwhile, in a still further embodiment of the induction motor, the induction motor may further comprise a rotary shaft positioned at a rotation center of the rotor. In such a case, the rotor further includes a core coupling means for fixedly coupling each core to the rotary shaft. In addition, the stator further includes an armature core coupling means for relatively rotatably fixing each armature core to the rotary shaft.

Further, in the still further embodiment of the induction motor, the core coupling means preferably includes a rotary disk having one surface coupled to one side of each of the cores arranged in multi stages in the radial direction, the rotary disk being fixedly coupled to the rotary shaft, the rotary disk being arranged in at least one stage in the axial direction. In addition, the armature core coupling means preferably includes a fixed disk having one surface coupled to one side of each of the armature cores arranged in one or more stages in the radial direction, the fixed disk being relatively rotatably coupled to the rotary shaft, the fixed disk being arranged in at least one stage in the axial direction.

Furthermore, in the still further embodiment of the induction motor, it is preferable that the rotor further include grooves formed on an outer periphery of the core opposite to the inner periphery in a radial direction and conductive bars inserted into the grooves formed on the outer periphery. In addition, it is preferable that the stator further include a plurality of armature coils wound around the armature cores positioned between the respective cores corresponding to the conductive bars inserted into the grooves formed in the outer periphery.

Moreover, in the still further embodiment of the induction motor, it is preferable that each core be detachably coupled to the rotary disk.

Also, in the induction motor, the conductive bar is preferably made of conductive material with small electric resistance, such as aluminum or copper.

### BRIEF DESCRIPTION OF DRAWINGS

FIG. 1 is a sectional view of one embodiment of an induction motor having a multi-stage rotor according to the present invention;

FIG. 2 is a side sectional view of the embodiment shown in FIG. 1;

FIG. 3 is a sectional view of another embodiment of the induction motor having a multi-stage rotor according to the present invention;

FIG. 4 is a side sectional view of the embodiment shown in FIG. 3;

FIG. 5 is a sectional view of a further embodiment of the induction motor having a multi-stage rotor according to the present invention; and

FIG. 6 is a sectional view of a still further embodiment of the induction motor having a multi-stage rotor according to the present invention.

### EXPLANATION OF REFERENCE NUMERALS FOR MAJOR PORTIONS SHOWN IN DRAWINGS

10: Fixed shaft 20: Rotor
21: First core 23: Second core
25: First conductive bar 27: Second conductive bar
29: Third conductive bar 31: Rotary disk
33: Bearing 35: Bolt
40: Stator 41: First armature core
43: Second armature core 45: First armature coil
47: Second armature coil 49: Third armature coil
51: Fixed disk 53: Bolt
110: Rotary shaft 120: Rotor
121: First core 123: Second core
125: First conductive bar 127: Second conductive bar
129: Third conductive bar 131: Rotary disk
133: Bolt 140: Stator
141: First armature core 143: Second armature core
145: First armature coil 147: Second armature coil
149: Third armature coil 153: Bolt
155: Bearing

### BEST MODE FOR CARRYING OUT THE INVENTION

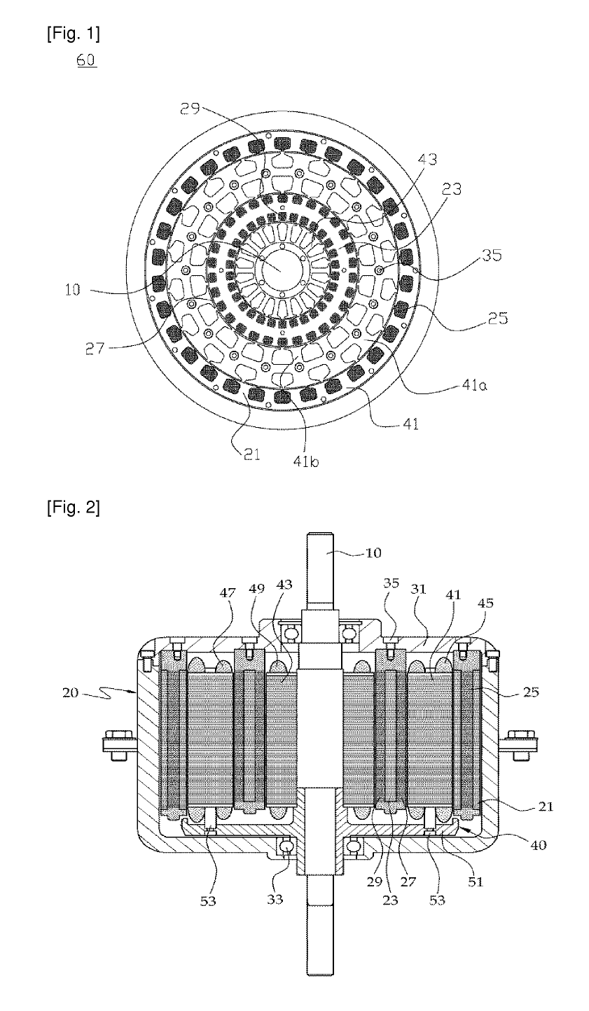

FIG. 1 is a sectional view of one embodiment of an induction motor having a multi-stage rotor according to the present invention, and FIG. 2 is a side sectional view of the embodiment shown in FIG. 1.

An induction motor 60 shown in FIG. 1 is configured such that a housing may rotate, and the induction motor 60 shown in FIG. 1 includes a fixed shaft 10, a rotor 20 and a stator 40.

The rotor 20 includes cores 21 and 23 and a rotary disk 31. The rotary disk 31 is rotatably coupled to the fixed shaft 10 through a bearing 33. The cores 21 and 23 have a cylindrical shape and are arranged in two stages in a radial direction. More specifically, the cores 21 and 23 are composed of the first core 21 with a great diameter and the second core 23 with a small diameter, and one side of each core 21 or 23 is detachably coupled to one surface of the rotary disk 31 by a bolt 35. Also, a plurality of grooves, each of which is formed in an axial direction on an inner periphery of the first core 21, are arranged along a circumferential direction such that first conductive bars 25, which will be described later, may be inserted therein. In addition, a plurality of grooves, each of which is formed in an axial direction on an outer or inner periphery of the second core 23, are arranged along a circumferential direction such that second conductive bars 27 and third conductive bars 29 may be inserted therein. The cores 21 and 23 may also be arranged in multi stages according to embodiments.

The conductive bars 25, 27 and 29 are composed of the first conductive bars 25, the second conductive bars 27 and the third conductive bars 29. The conductive bars 25, 27 and 29 are made of aluminum or copper. A plurality of the first conductive bars 25 are fixedly coupled to the inner periphery of the first core 21 in the circumferential direction. Also, a plurality of the second conductive bars 27 are fixedly coupled to the outer periphery of the second core 23 in the circumferential direction, and a plurality of the third conductive bars 29 are fixedly coupled to the inner periphery of the second core 23 in the circumferential direction.

The stator 40 includes a fixed disk 51, armature cores 41 and 43, and armature coils 45, 47 and 49. The fixed disk 51 is fixedly coupled to the fixed shaft 10. The armature cores 41 and 43 are composed of the first armature core 41 and the second armature core 43. The first armature core 41 is arranged between the first core 21 and the second core 23, and has grooves formed on outer and inner sides 41a and 41b thereof such that coils may be wound. One side of the first armature core 41 is fixed to one surface of the fixed disk 51 with a bolt 53.

The second armature core 43 is arranged in the second core 23, and is fixed to the fixed shaft 10. Also, the second armature core 43 has grooves formed on its inner side such that a coil may be wound. In addition, the armature cores 41 and 43 are made by laminating thin silicon steel sheets such that a magnetic line may allow to easily pass therethrough like the cores 21 and 23 and an eddy current may be decreased. The armature coils 45, 47 and 49 are composed of the first armature coil 45, the second armature coil 47 and the third armature coil 49. The first armature coil 45 is wound in the grooves formed on the outer side 41a of the first armature core 41, and the second armature coil 47 is wound in the grooves formed on the inner side 41b of the first armature core 41. Also, the third armature coil 49 is wound in the grooves formed on the second armature core 43. The armature coils 45, 47 and 49 may use either delta connection or Y connection.

If electric current is supplied to the armature coils 45, 47 and 49, a rotating magnetic field is generated, and the rotating magnetic field generated by the armature coils 45, 47 and 49 causes induced current to be generated in the conductive bars 25, 27 and 29. Thus, rotating force is generated by the rotating magnetic field generated by the armature coils 45, 47 and 49 and the induced current generated by the conductive bar 25, 27 and 29. Accordingly, the rotor 20 rotates about the fixed shaft 10.

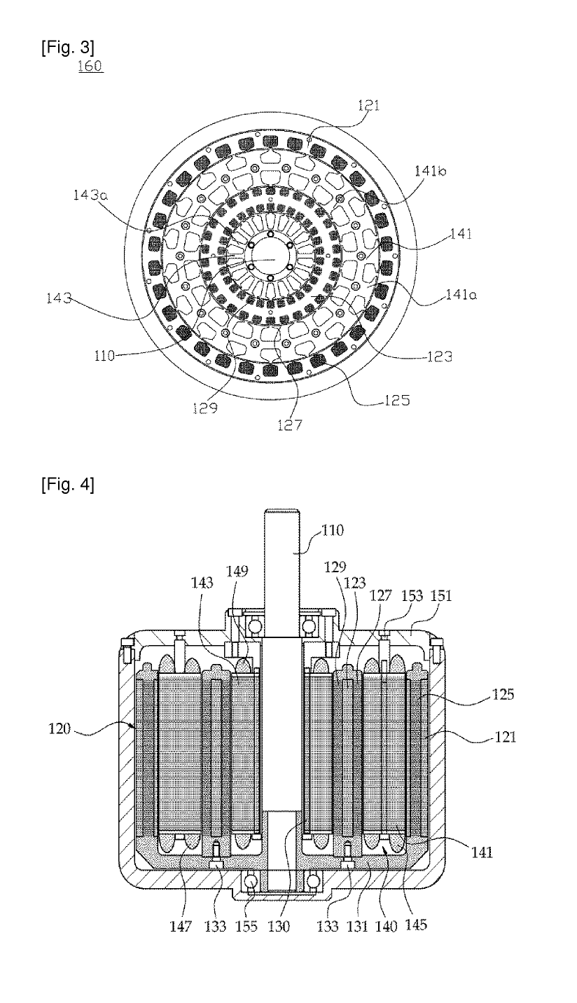

FIG. 3 is a sectional view of another embodiment of the induction motor having a multi-stage rotor according to the present invention, and FIG. 4 is a side sectional view of the embodiment shown in FIG. 3.

The induction motor shown in FIG. 3 is configured such that a shaft is rotated, and includes a rotary shaft 110, a rotor 120 and a stator 140.

The rotor 120 includes a rotary disk 131, cores 121 and 123 and conductive bars 125, 127 and 129. The rotary disk 131 is fixedly coupled to the rotary shaft 110. The cores 121 and 123 are arranged in a radial direction, and they are composed of the first core 121 and the second core 123 according to a size of radius. One side of the first core 121 is integrally coupled to one surface of the rotary disk 131, and a plurality of grooves, each of which is formed in an axial direction on an inner periphery of the first core 121, are arranged in a circumferential direction such that the first conductive bars 125, which will be described later, may be inserted therein. The second core 123 has one side detachably coupled to one surface of the rotary disk 131 with a bolt 133. Also, a plurality of grooves, each of which is formed in an axial direction on outer or inner periphery of the second core 123, are arranged along a circumferential direction such that the second conductive bars 127 and the third conductive bars 129 may be inserted therein. The conductive bars 125, 127 and 129 are composed of the first conductive bars 125, the second conductive bars 127 and the third conductive bars 129, and each of the conductive bars 125, 127 and 129 is inserted in each of the grooves formed in the inner and outer sides of the cores 121 and 123.

The stator 140 includes a fixed disk 151, armature cores 141 and 143 and armature coils 145, 147 and 149. The fixed disk 151 is coupled to a rotary shaft 110 through a bearing 155. The armature cores 141 and 143 are composed of the first armature core 141 and the second armature core 143. The first armature core 141 is arranged between the first core 121 and the second core 123 and detachably coupled to one side of the fixed disk 151 with a bolt 153. Also, grooves are formed on outer and inner sides 141a and 141b of the first armature core 141 such that coils may be wound. The second armature core 143 is arranged in the second core 123 and detachably coupled to the fixed disk 151 with a bolt. Grooves are formed on an outer side 143a of the second armature core 143 such that a coil is wound.

The armature coils 145, 147 and 149 are composed of the first armature coil 145, the second armature coil 147 and the third armature coil 149. The first armature coil 145 is wound on the outer side 141a of the first armature core 141, and the second armature coil 147 is wound on the inner side 141b of the first armature core 141. Also, the third armature coil 149 is wound on the outer side 143a of the second armature core 143.

If power is supplied to the armature coils 145, 147 and 149 of the induction motor, torque is generated, and this torque causes the rotor 120 to be rotated. Thus, the rotary shaft 110 fixed to the rotor 120 is rotated.

FIGS. 1 to 4 show embodiments of the inductor motor in which cores and armature cores are axially arranged in one row. Hereinafter, an embodiment of the induction motor in which cores and armature cores are axially arranged in two rows will be explained.

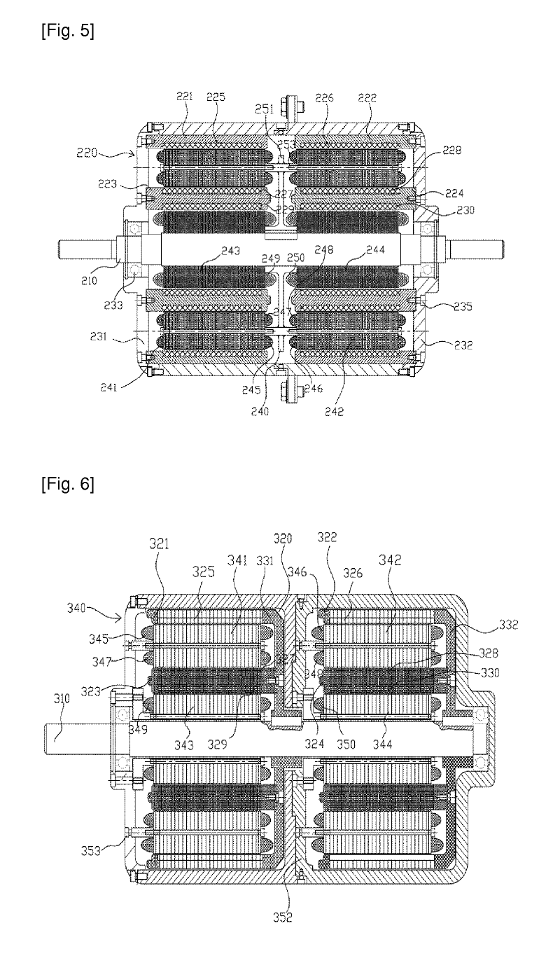

FIG. 5 shows an embodiment of the induction motor in which the embodiments of FIG. 1 are axially arranged in two rows.

The induction motor shown in FIG. 5 includes a fixed shaft 210, a rotor 220, and stator 240.

The rotor 220 includes cores 221, 222, 223 and 224 and rotary disks 231 and 232. The cores 221, 222, 223 and 224 are axially arranged in two rows. Each pair of the first-row cores 221 and 223 and the second-row cores 222 and 224 are arranged in two stages in a radial direction as in the embodiment shown in FIG. 1. The rotary disks 231 and 232 are composed of the first-row rotary disk 231 and the second-row rotary disk 232, and each rotary disk 231 or 232 is rotatably coupled to a fixed shaft 210 through a bearing 233. The first-row cores 221 and 223 are detachably coupled to one surface of the first-row rotary disk 231 with bolts 235, and the second-row cores 222 and 224 are detachably coupled to one surface of the second-row rotary disk 232 with bolts 235. Also, a plurality of conductive bars 225, 226, 227, 228, 229, or 230 are inserted into each core 221, 222, 223 or 224 in a circumferential direction, identically to FIG. 1.

The stator 240 includes a fixed disk 251, armature cores 241, 242, 243 and 244 and armature coils 245, 246, 247, 248, 249 and 250. The armature cores 241, 242, 243 and 244 are arranged in two rows in an axial direction. Each pair of the first-row armature cores 241 and 243 and the second-row armature cores 242 and 244 are arranged in two stages in a radial direction as in the embodiment shown in FIG. 1. Also, the armature coils 245, 246, 247, 248, 249 and 250 are wound around the armature cores 241, 242, 243 and 244.

The fixed disk 251 is fixedly coupled to the fixed shaft 210. The first-row armature cores 241 and 243 are coupled to one surface of the fixed disk 251, and the second-row armature cores 242 and 244 are coupled to the other surface of the fixed disk 251. Among the armature cores 241, 242, 243 and 244, the armature cores 241 and 242 are detachably coupled with bolts 253, and the armature cores 243 and 244 are forcibly fit around the fixed shaft 210 and thus fixed to the fixed disk 251. Thus, in the embodiment shown in FIG. 5, the rotor of the embodiment shown in FIG. 1 is provided with the cores in two stages in the axial direction, and the stator is provided with the armature cores in two stages in the axial direction.

FIG. 6 shows an embodiment of the induction motor in which the embodiments of FIG. 3 are axially arranged in two rows.

The induction motor shown in FIG. 6 includes a rotary shaft 310, a rotor 320 and a stator 340.

The rotor 320 includes rotary disks 331 and 332, cores 321, 322, 323 and 324, and conductive bars 325, 326, 327, 328, 329 and 330. The cores 321, 322, 323 and 324 are arranged in two rows in an axial direction. Each pair of the first-row cores 321 and 323 and the second-row cores 322 and 324 are radially arranged in two stages as in the embodiment shown in FIG. 3. Also, a plurality of the conductive bars 325, 326, 327, 328, 329 or 330 are inserted into each core 321, 322, 323 or 324 along a circumferential direction. The rotary disks 331 and 332 are composed of the first-row rotary disk 331 and the second-row rotary disk 332, and each rotary disk 331 or 332 is fixed to the rotary shaft 310. The first-row cores 321 and 323 are coupled to one surface of the first-row rotary disk 331, and the second-row cores 322 and 324 are coupled to one surface of the second-row rotary disk 332.

The stator 340 includes fixed disks 351 and 352, armature cores 341, 342, 343 and 344, and armature coils 345, 346, 347, 348, 349 and 350. The armature cores 341, 342, 343 and 344 are arranged in two stages in an axial direction. Each pair of the first-row armature cores 341 and 343 and the second-row armature cores 342 and 344 are radially arranged in two stages as in the embodiment shown in FIG. 3. Also, the armature coils 345, 346, 347, 348, 349 and 350 are wound around the armature cores 341, 342, 343 and 344.

The fixed disks 351 and 352 are arranged in two stages in an axial direction, and each fixed disk 351 or 352 is coupled to the rotary shaft 310 through a bearing so as to be rotatable relative thereto. The first-row armature cores 341 and 343 are detachably coupled to one surface of the first-row fixed disk 351 with bolts 353, and the second-row armature cores 342, 344 are detachably coupled to one surface of the second-row fixed disk 352 with bolts 4353.

### INDUSTRIAL APPLICABILITY

According to the present invention, there is provided an induction motor having rotors and stators arranged in multi stages in radial and axial directions, thereby generating great torque with a small volume. Also, when being used as a generator, the induction motor may generate great power even with small revolutions per minute (RPM).

The embodiments of the present invention should not be interpreted to limit the technical spirit of the present invention. The scope of the present invention is limited only by the appended claims, and it will be apparent that those skilled in the art can make various modifications and changes thereto from the technical spirit of the invention. Therefore, such modifications and changes will pertain to the scope of the invention if they are apparent to those having ordinary skill in the art.

1. An induction motor having a multi-stage rotor and being usable as a generator, comprising:
a rotor including a plurality of cylindrical cores arranged in multi stages in a radial direction, each of the cores having a plurality of grooves formed in an axial direction on a periphery thereof and arranged along a circumferential direction, and a plurality of conductive bars inserted into the grooves of the core of each stage; and
a stator including armature cores arranged in one or more stages in a radial direction to face the periphery having the grooves formed thereon, and a plurality of armature coils wound around the armature cores to correspond to the respective conductive bars.

2. The induction motor as claimed in claim 1, wherein the grooves are formed on an inner periphery of the cores.

3. The induction motor as claimed in claim 2, further comprising a fixed shaft positioned at a rotation center of the rotor, wherein the rotor further includes a core coupling means for rotatably coupling each core to the fixed shaft, and the stator further includes an armature core coupling means for fixing each armature core to the fixed shaft.

4. The induction motor as claimed in claim 3, wherein the core coupling means includes a rotary disk having one surface coupled to one side of each core, the rotary disk being rotatably coupled to the fixed shaft, and the armature core coupling means includes a fixed disk having one surface coupled to one side of each armature core arranged between the respective cores, the fixed disk being fixed to the fixed shaft.

5. The induction motor as claimed in claim 4, wherein the rotor further includes grooves formed on an outer periphery of the core opposite to the inner periphery in a radial direction and a plurality of conductive bars inserted into the grooves formed on the outer periphery, and the stator further includes a plurality of armature coils wound around the armature cores positioned between the respective cores corresponding to the conductive bars inserted into the grooves formed in the outer periphery.

6. The induction motor as claimed in claim 5, wherein among the armature cores, the armature core adjacent to the fixed shaft is fixed to the fixed shaft.

7. The induction motor as claimed in claim 6, wherein the core is detachably coupled to the rotary disk.

8. The induction motor as claimed in claim 2, further comprising a rotary shaft positioned at a rotation center of the rotor, wherein the rotor further includes a core coupling means for fixedly coupling each core to the rotary shaft, and the stator further includes an armature core coupling means for relatively rotatably fixing each armature core to the rotary shaft.

9. The induction motor as claimed in claim 8, wherein the core coupling means includes a rotary disk having one surface coupled to one side of each core, the rotary disk being fixed to the rotary shaft, and the armature core coupling means includes a fixed disk having one surface coupled to one side of each armature core, the fixed disk being relatively rotatably fixed to the rotary shaft.

10. The induction motor as claimed in claim 9, wherein the rotor further includes grooves formed on an outer periphery of the core opposite to the inner periphery in a radial direction and a plurality of conductive bars inserted into the grooves formed on the outer periphery, and the stator further includes a plurality of armature coils wound around the armature cores positioned between the respective cores corresponding to the conductive bars inserted into the grooves formed in the outer periphery.

11. The induction motor as claimed in claim 10, wherein the core is detachably coupled to the rotary disk.

12. The induction motor as claimed in claim 2, wherein the rotor further includes the cylindrical cores in one or more stages, which are further arranged in the axial direction, and the conductive bar, and the stator further includes the armature cores arranged to face the further arranged cylindrical cores and the plurality of the armature coils.

13. The induction motor as claimed in claim 12, further comprising a fixed shaft positioned at a rotation center of the rotor, wherein the rotor further includes a core coupling means for rotatably coupling each core to the fixed shaft, and the stator further includes an armature core coupling means for fixedly coupling each armature core to the fixed shaft.

14. The induction motor as claimed in claim 13, wherein the core coupling means includes a rotary disk having one surface coupled to one side of each of the cores arranged in multi stages in the radial direction, the rotary disk being rotatably coupled to the fixed shaft, the rotary disk being arranged in at least one stage in the axial direction, and the armature core coupling means includes a fixed disk having one surface coupled to one side of each of the armature cores arranged in one or more stages in the radial direction, the fixed disk being fixedly coupled to the fixed shaft, the fixed disk being arranged in at least one stage in the axial direction.

15. The induction motor as claimed in claim 14, wherein the rotor further includes grooves formed on an outer periphery of the core opposite to the inner periphery in a radial direction and conductive bars inserted into the grooves formed on the outer periphery, and the stator further includes a plurality of armature coils wound around the armature cores positioned between the respective cores corresponding to the conductive bars inserted into the grooves formed in the outer periphery.

16. The induction motor as claimed in claim 15, wherein among the armature cores, the armature core adjacent to the fixed shaft is fixed to the fixed shaft.

17. The induction motor as claimed in claim 16, wherein each core is detachably coupled to the rotary disk.

18. The induction motor as claimed in claim 12, further comprising a rotary shaft positioned at a rotation center of the rotor, wherein the rotor further includes a core coupling means for fixedly coupling each core to the rotary shaft, and the stator further includes an armature core coupling means for relatively rotatably fixing each armature core to the rotary shaft.

19. The induction motor as claimed in claim 18, wherein the core coupling means includes a rotary disk having one surface coupled to one side of each of the cores arranged in multi stages in the radial direction, the rotary disk being fixedly coupled to the rotary shaft, the rotary disk being arranged in at least one stage in the axial direction, and the armature core coupling means includes a fixed disk having one surface coupled to one side of each of the armature cores arranged in one or more stages in the radial direction, the fixed disk being relatively rotatably coupled to the rotary shaft, the fixed disk being arranged in at least one stage in the axial direction.

20. The induction motor as claimed in claim 19, wherein the rotor further includes grooves formed on an outer periphery of the core opposite to the inner periphery in a radial direction and conductive bars inserted into the grooves formed on the outer periphery, and the stator further includes a plurality of armature coils wound around the armature cores positioned between the respective cores corresponding to the conductive bars inserted into the grooves formed in the outer periphery.

21. The induction motor as claimed in claim 20, wherein each core is detachably coupled to the rotary disk.

22. The induction motor as claimed in claim 1, wherein the conductive bar is made of aluminum or copper.
